(19) United States
(12) Patent Application Publication
(10) Pub. No.: US 2025/0337097 A1
(43) Pub. Date: Oct. 30, 2025

(54) CYLINDRICAL BATTERY CELL INCLUDING SIDE VENT

(71) Applicant: GM Global Technology Operations LLC, Detroit, MI (US)

(72) Inventors: SriLakshmi KATAR, Troy, MI (US); Binsong LI, Troy, MI (US); Liang XI, Northville, MI (US); Ryan Patrick HICKEY, Austin, TX (US); Ben SOKOL, Ann Arbor, MI (US); Taylor Reed GARRICK, Bloomfield Hills, MI (US); Junjie MA, Novi, MI (US)

(21) Appl. No.: 18/651,095

(22) Filed: Apr. 30, 2024

(51) Int. Cl. H01M 50/358; H01M 10/613; H01M 10/6551; H01M 10/6556; H01M 50/213

(52) U.S. Cl. CPC H01M 50/358; H01M 10/613; H01M 10/6551; H01M 10/6556; H01M 50/213; H01M 2200/20

(57) ABSTRACT

A battery system including a battery cell. The battery cell including: an enclosure including a first end, a second end opposite to the first end, and a sidewall extending from the first end to the second end; a first terminal at a first end of the enclosure and a second terminal at a second end of the enclosure; an assembly of an anode electrode and a cathode electrode within the enclosure, the cathode electrode is connected to the first terminal and the anode electrode is connected to the second terminal; and a vent in the sidewall of the enclosure, the vent configured to open to release at least one of gas and ejecta out from within the enclosure when pressure within the enclosure exceeds a threshold.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a cylindrical battery cell including a side vent.

Electric vehicles (EVs), such as battery electric vehicles (BEVs), hybrid vehicles, and/or fuel cell vehicles, include one or more electric machines and a battery system including one or more battery cells, modules, and/or packs. Each battery includes electrodes with current collectors coated with active material. A power control system is used to control charging and/or discharging of the battery system during charging and/or driving.

### SUMMARY

The present disclosure includes, in various features, a battery system including a battery cell. The battery cell including: an enclosure including a first end, a second end opposite to the first end, and a sidewall extending from the first end to the second end; a first terminal at a first end of the enclosure and a second terminal at a second end of the enclosure; an assembly of an anode electrode and a cathode electrode within the enclosure, the cathode electrode is connected to the first terminal and the anode electrode is connected to the second terminal; and a vent in the sidewall of the enclosure, the vent configured to open to release at least one of gas and ejecta out from within the enclosure when pressure within the enclosure exceeds a threshold.

In further features, the vent is a first vent in the sidewall proximate to the first end, and the battery cell further includes a second vent in the sidewall proximate to the second end.

In further features, the anode electrode is directly connected to an inner surface of the enclosure at the second end of the enclosure.

In further features, a current collector disk made of a metallic material is seated on a metallic inner surface of the enclosure at the second end of the enclosure, the anode electrode is connected to the current collector disk.

In further features, the battery cell is a cylindrical battery cell and the sidewall is round.

In further features, the first end of the enclosure is ventless and the second end of the enclosure is ventless.

In further features, a ventilation conduit defining an opening aligned with the vent, the ventilation conduit venting to an exterior of a battery pack including the battery cell.

In further features, the ventilation conduit includes an internal thermal barrier.

In further features, the battery cell is one of a plurality of battery cells all configured identically, and the ventilation conduit defines a plurality of openings spaced apart and aligned with the vent of each one of the plurality of battery cells.

In further features, a base cooling conduit extends along the second end of each one of the plurality of battery cells, the base cooling conduit configured to direct coolant along the second end of each one of the plurality of battery cells to cool the plurality of battery cells.

In further features, a side cooling conduit extends along sides of the plurality of battery cells, the side cooling conduit configured to direct coolant along the sides of the plurality of battery cells to cool the plurality of battery cells.

The present disclosure further includes, in various features, a battery system including a cylindrical battery cell. The cylindrical battery cell includes: an enclosure including a top plate, a bottom plate, and a sidewall extending from the top plate to the bottom plate, the bottom plate is directly welded to the sidewall; a first terminal at a first end of the enclosure and a second terminal at a second end of the enclosure; an assembly of an anode electrode and a cathode electrode within the enclosure, the cathode electrode is connected to the first terminal and the anode electrode is connected to the second terminal; and a vent in the sidewall of the enclosure, the vent configured to open to release at least one of gas and ejecta out from within the enclosure when pressure within the enclosure exceeds a threshold. A ventilation conduit defines an opening aligned with the vent and includes a thermal barrier film. The ventilation conduit vents to an exterior of a battery pack including the cylindrical battery cell. A cooling conduit is adjacent to the cylindrical battery cell configured to conduct coolant for cooling the cylindrical battery cell.

In further features, the anode electrode is directly connected to an inner surface of the bottom plate.

In further features, a current collector disk is made of a metallic material seated on the bottom plate, the anode electrodes are connected to the current collector disk.

In further features, the vent is one of a plurality of vents in the sidewall of the enclosure.

In further features, the cooling conduit is adjacent to the bottom plate.

In further features, the cooling conduit is adjacent to the sidewall.

The present disclosure also includes, in various features, a battery pack including a plurality of cylindrical battery cells. Each one of the plurality of cylindrical battery cells includes: an enclosure including a top plate, a bottom plate, and a sidewall extending from the top plate to the bottom plate, the bottom plate is directly welded to the sidewall; a first terminal at a first end of the enclosure and a second terminal at a second end of the enclosure; an assembly of an anode electrode and a cathode electrode within the enclosure, the anode electrode is directly connected to the bottom plate; and a vent in the sidewall of the enclosure, the vent configured to open to release at least one of gas and ejecta out from within the enclosure when pressure within the enclosure exceeds a threshold. A ventilation conduit extends along the plurality of cylindrical battery cells and defines a plurality of openings. Each one of the plurality of openings is aligned with one of the vents of the plurality of cylindrical battery cells. The ventilation conduit vents to an exterior of the battery pack. A base cooling conduit is adjacent to the bottom plate of each one of the plurality of cylindrical battery cells and is configured to conduct coolant to cool the plurality of cylindrical battery cells.

In further features, a base cooling conduit is adjacent to the sidewall of each one of the plurality of cylindrical battery cells and is configured to conduct coolant to cool the plurality of cylindrical battery cells.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates a cylindrical battery cell, a venting system, and a cooling system in accordance with the present disclosure;

FIG. 2 is a cross-sectional view of an exemplary battery cell including one or more side vents in accordance with the present disclosure;

FIG. 3 is a cross-sectional view of the cylindrical battery cell of FIG. 1 showing a side vent and an upper area proximate to the side vent;

FIG. 4A is a cross-sectional view of a bottom area of the cylindrical battery cell of FIG. 1;

FIG. 4B is a cross-sectional view of a bottom area of an additional configuration for the cylindrical battery cell of FIG. 1;

FIG. 5 is a plan view of a venting and cooling system in accordance with the present disclosure for the cylindrical battery cell of FIG. 1; and

FIG. 6 is a plan view of an additional venting and cooling system in accordance with the present disclosure for the cylindrical battery cell of FIG. 1.

In the drawings, reference numbers may be reused to identify similar and/or identical elements.

### DETAILED DESCRIPTION

A battery cell, such as a lithium-ion cylindrical battery cell, may include a vent to release gas and any other ejecta out from within an enclosure of the battery cell when pressure within the enclosure reaches a threshold, such as during a thermal event. Arranging the vent at a bottom plate of the battery cell eliminates the availability of base cooling due to the need for a venting clearance below the battery cell. A battery cell with a vent at the base plate is typically cooled with a cooling ribbon at a side of the battery cell, which is not efficient or uniform due to low through-plane thermal conductivity of the jelly roll.

The present disclosure provides one or more vents at a sidewall of the battery enclosure, such as where there is a gap between the jelly roll and the cell can. Such sidewall vents facilitate venting, and permit highly efficient base cooling. Welding a bottom plate of the battery cell enclosure to flattened continuous, or multiple, electrode tabs with a large metal-metal connection paves a continuous heat transfer path to the bottom plate of the cell to take advantage of high in-plane thermal conductivity of the jelly roll. The large metal-metal connection between the bottom plate of the battery cell can and jelly roll current collector foil, either directly or indirectly by way of an anode current collector disk, provides high thermal conductivity to improve cooling efficiency.

Moving the vent from the bottom of the can to the side enables welding flattened negative electrode tabs directly or indirectly to the can bottom without isolation space, which provides various advantages including: saving about 2 mm of space in cell height direction and increasing cell capacity by about 3% for 4680 cylindrical cells; reduced cell resistance; and simplified manufacturing. The configuration of the present disclosure reduces cell temperature rise during fast charge and discharge, reduces cell can length, improves cell performance especially for high-power cells, and increases the battery cell life cycle due to homogeneous cell operating temperatures.

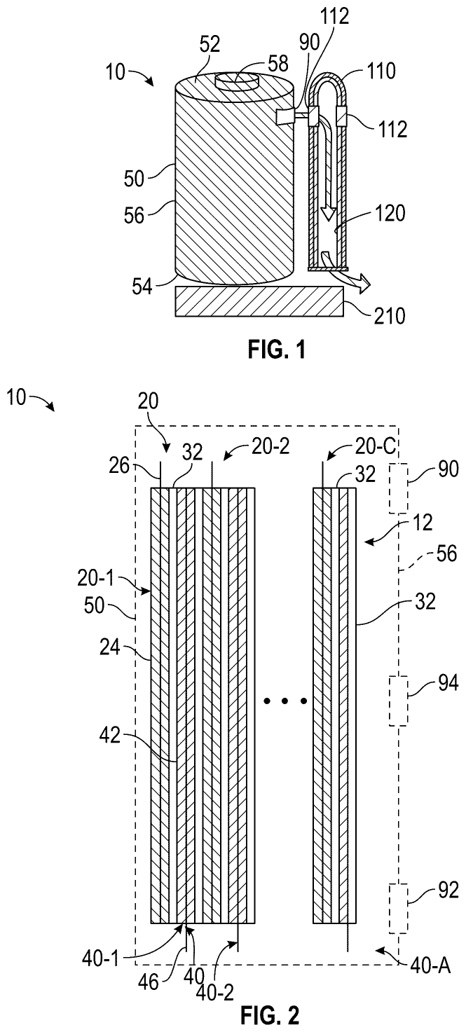

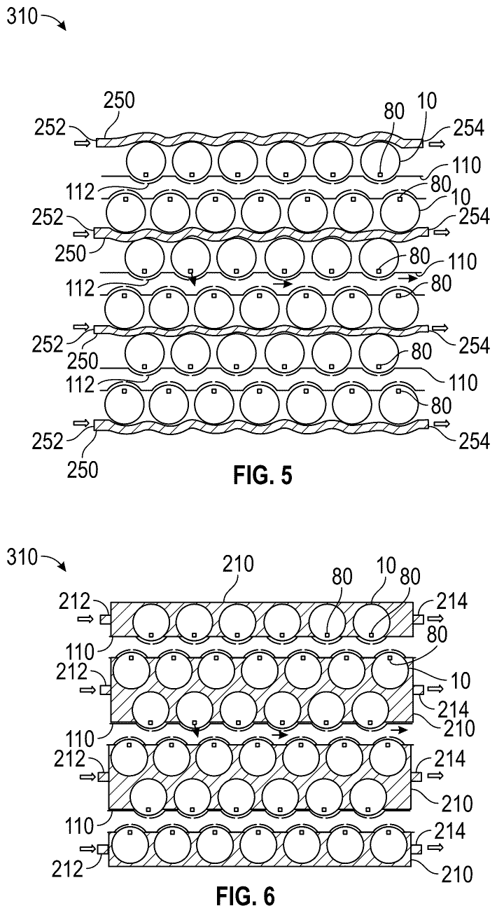

FIG. 1 illustrates a battery cell 10 in accordance with the present disclosure. The battery cell 10 may be configured for use in any suitable application, such as any suitable automotive or non-automotive application. The battery cell 10 is a cylindrical battery cell. As illustrated in FIGS. 5 and 6, the battery cell 10 is typically included in a battery pack 310 of a plurality of battery cells, each of which is the same as, or similar to, the battery cell 10. Adjacent to the battery cell 10 is a ventilation conduit 110 and a cooling conduit including a base cooling conduit 210 (FIGS. 1 and 6) and/or a side cooling conduit 250 (FIGS. 1 and 5), which are described in detail herein.

With additional reference to FIG. 2, the battery cell 10 includes one C cathode electrode 20, one A anode electrode 40, and two S separators 32 arranged in a predetermined sequence and wound together into a spiral or cylindrical shape often referred to as a jelly roll 12. The jelly roll 12 is seated in an enclosure 50. The C cathode electrodes include cathode active layers 24 arranged on one or both sides of cathode current collectors 26. The A anode electrodes include anode active layers 42 arranged on one or both sides of the anode current collectors 46. The C cathode electrode is wound to multiple circles 20-1, 20-2, . . . , and 20-C. The A anode electrode is wound to multiple circles 40-1, 40-2, . . . , and 40-A. The anode has more circles than the cathode to ensure an entirety of the cathode area is paired with the anode for full utilization. The two separators stay between cathode layer and anode layer and separate them.

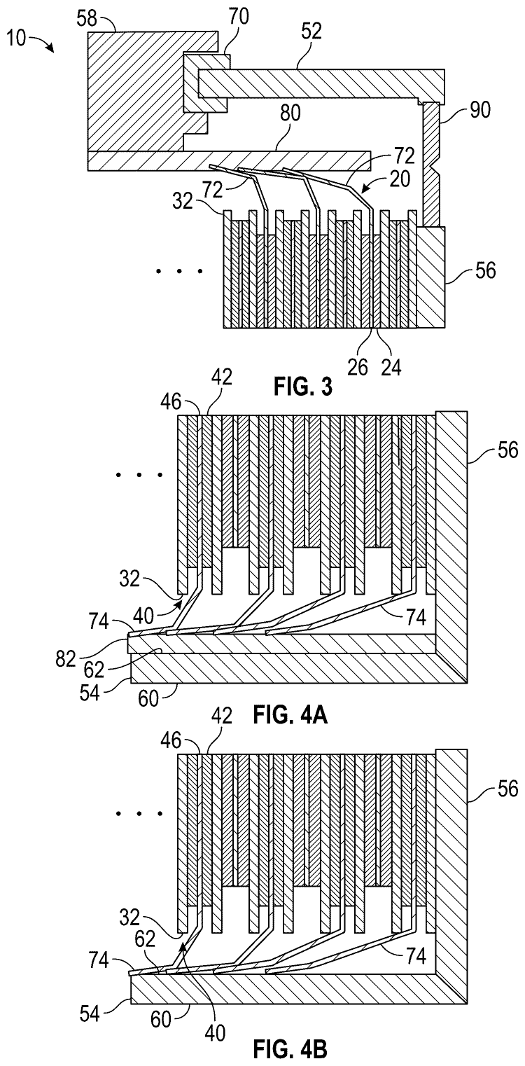

With continued reference to FIGS. 1 and 2, and additional reference to FIGS. 3, 4A, and 4B, the enclosure 50 includes a top plate 52, a bottom plate 54, and a sidewall 56 extending from the top plate 52 to the bottom plate 54. The bottom plate 54 is directly welded to the sidewall 56. Welding the bottom plate 54, instead of crimping the bottom plate to a grooved cylindrical cell can, provides various advantages. For example, welding instead of crimping eliminates any narrow space in a groove area to fully use space of a bottom area of the can for higher cell energy density, and eliminates extra can wall material in the groove area and bottom plate gasket to lighten the battery cell. The bottom plate 54 may be a Ni-plated steel plate, for example. A first terminal 58 is adjacent to the top plate 52. A second terminal is at an outer surface 60 of the bottom plate 54. The first terminal 58 is a cathode terminal and the second terminal at the outer surface 60 is an anode terminal. Between the first terminal 58 and the top plate 52 is a gasket 70.

The cathode current collectors 26 include cathode tabs 72. The anode current collectors 46 include anode tabs 74. The cathode tabs 72 are connected to a positive current collector plate 80 (FIG. 3), which is connected to the first terminal 58 (the positive terminal). The anode tabs 74 are connected directly to, or indirectly to, an inner surface 62 of the bottom plate 54. In FIG. 4A, the anode tabs 74 are indirectly connected to the bottom plate 54 by way of an anode current collector disk 82, which is seated on the inner surface 62 of the bottom plate 54. In FIG. 4B, the anode tabs 74 are directly connected to the bottom plate 54. The present disclosure encompasses a tab-less connection, a single tab connection, or multiple tab connection between the jelly roll and the enclosure 50.

At the sidewall 56 of the enclosure 50 are one or more vents configured to open to relieve pressure within the enclosure 50, such as during a thermal runaway event. Any suitable number of vents may be included. FIGS. 1 and 3 illustrate a first vent 90 at an upper area of the sidewall 56 near the top plate 52. FIG. 2 illustrates a second vent 92 at a lower area of the sidewall 56 near the bottom plate 54, and a third vent 94 between the first vent 90 and the second vent 92. The enclosure 50 may include any one or more of the first vent 90, the second vent 92, and the third vent 94. One or more of the vents 90, 92, 94 may be arranged at any suitable position about a circumference of the sidewall 56. Thus, the vents 90, 92, 94 may be aligned vertically or spaced apart radially about the sidewall 56. The present disclosure also provides for multiple vents around the circumference of the sidewall 56 at the same height.

The vents 90, 92, and 94 are each configured in any suitable manner to open to release gas out from within the enclosure 50 when pressure of the gas within the enclosure 50 exceeds a predetermined threshold, such as during a thermal runaway event. Both the top plate 52 and the bottom plate 54 may be configured without vents. In some applications, the top plate 52 includes a vent along with any of the vents 90, 92, 94 at the sidewall 56. Lack of a vent at the bottom plate 54 advantageously permits cooling with the cooling conduit 210 (FIGS. 1 and 6), as described herein.

The ventilation conduit 110 illustrated in FIGS. 1, 5, and 6 is generally configured as a ribbon extending along the sidewalls 56 of a plurality of the battery cells 10 of the battery pack 310. The ventilation conduit 110 is arranged within the battery pack 310 between adjacent rows of the battery cells 10. The ventilation conduit 110 includes a plurality of openings 112 aligned with vents of the battery cells 10 to receive gas and ejecta released through the vents. The openings 112 of the ventilation conduit 110 may be aligned with one or more of the first vents 90, the second vents 92, and the third vents 94. In the example of FIG. 1, the opening 112 is aligned with the first vent 90. The ventilation conduit 110 includes openings 112 on opposite sides of the ventilation conduit 110 to receive gas and ejecta from the battery cells 10 on opposite sides of the ventilation conduit 110. A double-sided ventilation conduit 110 provides lower pressure rise in the ventilation conduit at pack level, and higher energy absorption from gas and ejecta on the way to pack exit.

The ventilation conduit 110 includes an internal thermal barrier 120, which may be any suitable coating, layer, etc. made of any suitable material configured to protect the ventilation conduit 110 from direct vent gas and ejecta exposure and mitigate thermal runaway propagation. The internal thermal barrier 120 may be made of mica, for example. As illustrated in FIGS. 5 and 6, the battery pack 310 may include a plurality of the ventilation conduits 110, each between an adjacent row of the battery cells 10. The ventilation conduits 110 include outlets for venting to an area external to the battery pack 310.

The battery pack 310 includes at least one of the base cooling conduit 210 and the side cooling conduit 250. FIG. 1 illustrates the battery cell 10 seated on the base cooling conduit 210. FIG. 6 illustrates the battery pack 310 including a plurality of battery cells 10 seated on the base cooling conduits 210, which can be either single cooling conduits with multiple inlets 212 and multiple outlets 214, or a plurality of the base cooling conduits 210, which each include an inlet 212 and an outlet 214. The base cooling conduits 210 are configured for circulation therethrough of any suitable coolant to cool the battery cells 10. The bottom plate 54 of each battery cell 10 is in direct or indirect contact with a surface of the base cooling conduits 210. Coolant enters the base cooling conduits 210 through the inlets 212 and exits through the outlets 214. The coolant is cooled to any suitable temperature by any suitable heat exchanger or other cooling device. Heat of the battery cells 10 is transferred to the coolant, which transfers heat out of the battery pack 310.

FIG. 5 illustrates the battery pack 310 including a plurality of the side cooling conduits 250 running along the sidewalls 56 of a plurality of the battery cells 10. The side cooling conduits 250 may be arranged between two rows of the battery cells 10 such that each cooling conduit 250 cools multiple battery cells 10 on opposite sides of the cooling conduits 250. Each side cooling conduit 250 includes an inlet 252 and an outlet 254. The side cooling conduits 250 are generally configured as ribbons weaving along the sidewalls 56 of the battery cells 10 between adjacent rows of the battery cells 10. Coolant enters the side cooling conduits 250 through the inlets 252 and exits through the outlets 254. The coolant is cooled to any suitable temperature by any suitable cooling device. Heat of the battery cells 10 is transferred to the coolant, which transfers heat out of the battery pack 310.

The battery pack 310 may be cooled by only the base cooling conduits 210, only the side cooling conduits 250, or both the base cooling conduits 210 and the side cooling conduits 250. In some applications, the ventilation conduits 110 may be configured as cooling conduits in addition to ventilation conduits. For example, during typical operation with the vents 90, 92, 94 closed, air may be circulated through the ventilation conduits 110 for air cooling.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery system comprising:
a battery cell including:
an enclosure including a first end, a second end opposite to the first end, and a sidewall extending from the first end to the second end;
a first terminal at a first end of the enclosure and a second terminal at a second end of the enclosure;
an assembly of an anode electrode and a cathode electrode within the enclosure, the cathode electrode is connected to the first terminal and the anode electrode is connected to the second terminal; and
a vent in the sidewall of the enclosure, the vent configured to open to release at least one of gas and ejecta out from within the enclosure when pressure within the enclosure exceeds a threshold.

2. The battery system of claim 1, wherein the vent is a first vent in the sidewall proximate to the first end; and
the battery cell further includes a second vent in the sidewall proximate to the second end.

3. The battery system of claim 1, wherein the anode electrode is directly connected to an inner surface of the enclosure at the second end of the enclosure.

4. The battery system of claim 1, further comprising a current collector disk made of a metallic material seated on a metallic inner surface of the enclosure at the second end of the enclosure, the anode electrode is connected to the current collector disk.

5. The battery system of claim 1, wherein the battery cell is a cylindrical battery cell and the sidewall is round.

6. The battery system of claim 1, wherein the first end of the enclosure is ventless and the second end of the enclosure is ventless.

7. The battery system of claim 1, further comprising a ventilation conduit defining an opening aligned with the vent, the ventilation conduit venting to an exterior of a battery pack including the battery cell.

8. The battery system of claim 7, wherein the ventilation conduit includes an internal thermal barrier.

9. The battery system of claim 7, wherein the battery cell is one of a plurality of battery cells all configured identically; and
wherein the ventilation conduit defines a plurality of openings spaced apart and aligned with the vent of each one of the plurality of battery cells.

10. The battery system of claim 9, further comprising a base cooling conduit extending along the second end of each one of the plurality of battery cells, the base cooling conduit configured to direct coolant along the second end of each one of the plurality of battery cells to cool the plurality of battery cells.

11. The battery system of claim 9, further comprising a side cooling conduit extending along sides of the plurality of battery cells, the side cooling conduit configured to direct coolant along the sides of the plurality of battery cells to cool the plurality of battery cells.

12. The battery system of claim 11, further comprising a base cooling conduit extending along the second end of each one of the plurality of battery cells, the base cooling conduit configured to direct coolant along the second end of each one of the plurality of battery cells to cool the plurality of battery cells.

13. A battery system comprising:
a cylindrical battery cell including:
an enclosure including a top plate, a bottom plate, and a sidewall extending from the top plate to the bottom plate, the bottom plate is directly welded to the sidewall;
a first terminal at a first end of the enclosure and a second terminal at a second end of the enclosure;
an assembly of an anode electrode and a cathode electrode within the enclosure, the cathode electrode is connected to the first terminal and the anode electrode is connected to the second terminal; and
a vent in the sidewall of the enclosure, the vent configured to open to release at least one of gas and ejecta out from within the enclosure when pressure within the enclosure exceeds a threshold;
a ventilation conduit defining an opening aligned with the vent and including a thermal barrier film, the ventilation conduit vents to an exterior of a battery pack including the cylindrical battery cell; and
a cooling conduit adjacent to the cylindrical battery cell configured to conduct coolant for cooling the cylindrical battery cell.

14. The battery system of claim 13, wherein the anode electrode is directly connected to an inner surface of the bottom plate.

15. The battery system of claim 13, further comprising a current collector disk made of a metallic material seated on the bottom plate, the anode electrodes are connected to the current collector disk.

16. The battery system of claim 13, wherein the vent is one of a plurality of vents in the sidewall of the enclosure.

17. The battery system of claim 13, wherein the cooling conduit is adjacent to the bottom plate.

18. The battery system of claim 13, wherein the cooling conduit is adjacent to the sidewall.

19. A battery system comprising:
a battery pack including a plurality of cylindrical battery cells, each one of the plurality of cylindrical battery cells including:
an enclosure including a top plate, a bottom plate, and a sidewall extending from the top plate to the bottom plate, the bottom plate is directly welded to the sidewall;
a first terminal at a first end of the enclosure and a second terminal at a second end of the enclosure;
an assembly of an anode electrode and a cathode electrode within the enclosure, the anode electrode is directly connected to the bottom plate; and
a vent in the sidewall of the enclosure, the vent configured to open to release at least one of gas and ejecta out from within the enclosure when pressure within the enclosure exceeds a threshold;
a ventilation conduit extending along the plurality of cylindrical battery cells and defining a plurality of openings, each one of the plurality of openings is aligned with one of the vents of the plurality of cylindrical battery cells, the ventilation conduit vents to an exterior of the battery pack; and
a base cooling conduit adjacent to the bottom plate of each one of the plurality of cylindrical battery cells and configured to conduct coolant to cool the plurality of cylindrical battery cells.

20. The battery system of claim 19, further comprising a base cooling conduit adjacent to the sidewall of each one of the plurality of cylindrical battery cells and configured to conduct coolant to cool the plurality of cylindrical battery cells.
